(19) United States
(12) Patent Application Publication
(10) Pub. No.: US 2022/0196115 A1
(43) Pub. Date: Jun. 23, 2022

(54) CHAIN

(71) Applicant: TSUBAKIMOTO CHAIN CO., Osaka (JP)

(72) Inventors: Yusuke Saito, Osaka (JP); Toyonaga Saitoh, Osaka (JP); Sota Yamaguchi, Osaka (JP); Shota Suyama, Osaka (JP)

(73) Assignee: TSUBAKIMOTO CHAIN CO., Osaka (JP)

(21) Appl. No.: 17/546,849

(22) Filed: Dec. 9, 2021

(30) Foreign Application Priority Data
Dec. 22, 2020 (JP) 2020-212701
Jan. 28, 2021 (JP) 2021-012305

(51) Int. Cl. F16G 13/07

(52) U.S. Cl. CPC F16G 13/07

(57) ABSTRACT

An object is to prevent a loss in sprocket drive efficiency and chain slacking. The chain includes a plurality of inner link plates, a plurality of outer link plates, and a plurality of pins. At least any of the plurality of inner link plates, outer link plates, or pins include a hardened surface layer on part or all of sliding surfaces that slide against other components, the hardened surface layer containing one of Cr carbide, Ti carbide, V carbide, Nb carbide, Cr nitride, Ti nitride, V nitride, and Nb nitride.

### BACKGROUND OF THE INVENTION

### 1. Field of the Invention

The present disclosure relates to a chain.

### 2. Description of the Related Art

Japanese Patent Application Publication No. 2017-105438 discloses a technique relating to a chain. The chain described in Japanese Patent Application Publication No. 2017-105438 has alternating succession of outer links and inner links that are connected to each other at respective connection ends thereof by rivets.

### SUMMARY OF THE INVENTION

In applications where the chain drives front and rear sprockets, for example, in bicycles, it is preferable that at least one of the components of the chain that slide against each other be highly wear resistant, to avoid a loss in drive efficiency and to prevent slackness in the chain.

The chain according to a first feature of the present disclosure is a chain that includes a plurality of inner link plates, a plurality of outer link plates, and a plurality of pins, at least any of the plurality of inner link plates, the plurality of outer link plates, or the plurality of pins including a hardened surface layer on part or all of sliding surfaces that slide against other components, the hardened surface layer containing one of Cr carbide, Ti carbide, V carbide, Nb carbide, Cr nitride, Ti nitride, V nitride, and Nb nitride.

According to the first feature of the chain, the hardened surface layer gives higher wear resistance to the inner link plates, outer link plates, or pins, which minimizes elongation of the chain and improves drive efficiency.

The chain according to a second feature of the present disclosure is a chain that includes a plurality of inner link plates, a plurality of outer link plates, a plurality of pins, and a plurality of rollers, the plurality of rollers including a hardened surface layer on part or all of sliding surfaces that slide against other components, the hardened surface layer containing one of Cr carbide, Ti carbide, V carbide, Nb carbide, Cr nitride, Ti nitride, V nitride, and Nb nitride.

According to the second feature of the chain, the hardened surface layer gives higher wear resistance to the rollers, which minimizes elongation of the chain and improves drive efficiency.

The chain according to a third feature of the present disclosure is a chain that includes a plurality of inner link plates, a plurality of outer link plates, a plurality of pins, and a plurality of bushings, the plurality of bushings including a hardened surface layer on part or all of sliding surfaces that slide against other components, the hardened surface layer containing one of Cr carbide, Ti carbide, V carbide, Nb carbide, Cr nitride, Ti nitride, V nitride, and Nb nitride.

According to the third feature of the chain, the hardened surface layer gives higher wear resistance to the bushings, which minimizes elongation of the chain and improves drive efficiency.

According to a fourth feature of the chain in the present disclosure, the hardened surface layer has a sliding surface hardness of 1000 HV or more and 3500 HV or less.

According to the fourth feature of the chain, the pins have high wear resistance compared to those having a sliding surface hardness of their hardened layer out of the range specified above, which minimizes elongation of the chain and improves drive efficiency.

According to a fifth feature of the chain in the present disclosure, the hardened surface layer has a higher sliding surface hardness than a surface hardness of sliding surfaces of other components that slide against the hardened surface layer.

According to the fifth feature of the chain, the pins have high wear resistance compared to those having a sliding surface hardness of their hardened layer not higher than the surface hardness of the sliding surfaces of inner links, which minimizes elongation of the chain and improves drive efficiency.

According to a sixth feature of the chain in the present disclosure, the plurality of pins include a connecting pin for connecting the chain in an endless loop, and the connecting pin has a surface condition that is different from that of other pins.

According to the sixth feature of the chain, the connecting pin will suffer more wear than other pins. After a long time of use, the chain pitch with the connecting pin in the middle will become larger than that of other parts of the chain. This generates a clicking feeling or sound during use, based on which the user can know the chain has elongated.

According to a seventh feature of the chain in the present disclosure, the plurality of inner link plates include a first inner link plate and a second inner link plate. The plurality of outer link plates include a first outer link plate and a second outer link plate. The plurality of pins include a first pin. The first inner link plate includes: a first inner link end, which includes a first inner link opening having a first inner link center axis, and a first annular axial protrusion circumferentially surrounding the first inner link opening around the first inner link center axis; a second inner link end, which includes a second inner link opening having a second inner link center axis extending parallel to the first inner link center axis, and a second annular axial protrusion circumferentially surrounding the second inner link opening around the second inner link center axis; a first inner link intermediate portion connecting the first inner link end and the second inner link end; a first inner link surface; and a second inner link surface on an opposite side from the first inner link surface in a first inner link axial direction along the first inner link center axis. The first annular axial protrusion includes a first proximal end connected to the first inner link surface, and a first distal end. The second annular axial protrusion includes a second proximal end connected to the first inner link surface, and a second distal end. The second inner link plate includes: a third inner link end, which includes a third inner link opening having a third inner link center axis, and a third annular axial protrusion circumferentially surrounding the third inner link opening around the third inner link center axis; a fourth inner link end, which includes a fourth inner link opening having a fourth inner link center axis extending parallel to the third inner link center axis, and a fourth annular axial protrusion circumferentially surrounding the fourth inner link opening around the fourth inner link center axis; a second inner link intermediate portion connecting the third inner link end and the fourth inner link end; a third inner link surface designed to face the first inner link surface of the first inner link plate in the first inner link axial direction in a state in which the chain is assembled; and a fourth inner link surface on an opposite side from the third inner link surface in a second inner link axial direction along the third inner link center axis. The third annular axial protrusion has a third proximal end connected to the third inner link surface, and a third distal end that is opposite the first distal end of the first annular axial protrusion in a state in which the chain is assembled. The fourth annular axial protrusion has a fourth proximal end connected to the third inner link surface, and a fourth distal end that is opposite the second distal end of the second annular axial protrusion in a state in which the chain is assembled. The first outer link plate is designed to adjoin the first inner link plate without another inner link plate or another outer link plate therebetween in a state in which the chain is assembled. The first outer link plate includes: a first outer link end, which includes a first outer link opening having a first outer link center axis; a second outer link end, which includes a second outer link opening having a second outer link center axis extending parallel to the first outer link center axis; and a first outer link intermediate portion connecting the first outer link end and the second outer link end; a first outer link surface; and a second outer link surface on an opposite side from the first outer link surface in a first outer link axial direction along the first outer link center axis. The second outer link plate is designed to adjoin the second inner link plate without another inner link plate or another outer link plate therebetween in a state in which the chain is assembled. The second outer link plate includes: a third outer link end, which includes a third outer link opening having a third outer link center axis; a fourth outer link end, which includes a fourth outer link opening having a fourth outer link center axis extending parallel to the third outer link center axis; a second outer link intermediate portion connecting the third outer link end and the fourth outer link end; a third outer link surface designed to face the first outer link surface of the first outer link plate in the first outer link axial direction in a state in which the chain is assembled; and a fourth outer link surface on an opposite side from the third outer link surface in a second outer link axial direction along the third outer link center axis. The first pin is designed to pass through the first outer link opening, the third outer link opening, the first inner link opening, and the third inner link opening in a state in which the chain is assembled, and includes a first outer circumferential surface that slides against the first annular axial protrusion and the third annular axial protrusion when the chain is in use.

According to the seventh feature, the chain having the first inner link plate, second inner link plate, first outer link plate, second outer link plate, and first pin has higher wear resistance, which minimizes elongation of the chain and improves drive efficiency.

According to an eighth feature of the chain in the present disclosure, the plurality of pins include a second pin. The second pin is designed to pass through the second outer link opening, fourth outer link opening, second inner link opening, and fourth inner link opening in a state in which the chain is assembled, and includes a second outer circumferential surface that slides against the second annular axial protrusion and the fourth annular axial protrusion when the chain is in use.

According to the eighth feature, the chain having the second pin has higher wear resistance, which minimizes elongation of the chain and improves drive efficiency.

According to a ninth feature of the chain in the present disclosure, the first proximal end of the first annular axial protrusion is made of a single material and integrally connected to the first inner link surface, and the second proximal end of the second annular axial protrusion is made of a single material and integrally connected to the first inner link surface.

According to the ninth feature, the chain has even higher wear resistance than those having annular axial protrusions not made of a single material and integrally connected, which minimizes elongation of the chain and improves drive efficiency.

According to a tenth feature of the chain in the present disclosure, the first inner link plate includes a first inner link sliding surface formed on an inner circumferential surface of the first inner link opening and on an inner circumferential surface of the first annular axial protrusion, extending parallel to the first inner link center axis, and sliding against the first outer circumferential surface of the first pin. The second inner link plate includes a second inner link sliding surface formed on an inner circumferential surface of the third inner link opening and on an inner circumferential surface of the third annular axial protrusion, extending parallel to the third inner link center axis, and sliding against the first outer circumferential surface of the first pin.

According to the tenth feature, the chain having the first inner link sliding surface and the second inner link sliding surface has higher wear resistance, which minimizes elongation of the chain and improves drive efficiency.

According to an eleventh feature of the chain in the present disclosure, the first inner link sliding surface has a first axial sliding surface length of 0.5 mm or more and 3.5 mm or less in the first inner link axial direction, and the second inner link sliding surface has a second axial sliding surface length of 0.5 mm or more and 3.5 mm or less in the second inner link axial direction.

According to the eleventh feature, the chain has even higher wear resistance than those having a first axial sliding surface length and a second axial sliding surface length out of the ranges specified above, which minimizes elongation of the chain and improves drive efficiency. Moreover, the chain realizes smooth engagement between the inner link plates and the sprocket teeth of the sprockets, and smooth gear changes between adjacent sprockets, as compared to those having a first axial sliding surface length and a second axial sliding surface length out of the ranges specified above.

According to a twelfth feature of the chain in the present disclosure, the first inner link sliding surface has a first inner link sliding surface hardness of 200 HV or more and 2500 HV or less, and the second inner link sliding surface has a second inner link sliding surface hardness of 200 HV or more and 2500 HV or less.

According to the twelfth feature, the chain has even higher wear resistance than those having a first inner link sliding surface hardness and a second inner link sliding surface hardness out of the ranges specified above, which minimizes elongation of the chain and improves drive efficiency.

According to a thirteenth feature of the chain in the present disclosure, the first inner link sliding surface has a first axial sliding surface length defined in the first inner link axial direction, and the second inner link sliding surface has a second axial sliding surface length defined in the second inner link axial direction. The first pin includes, in a state in which the chain is assembled, a first pin center axis, a first pin axial end face, a second pin axial end face, and a first shaft body extending between the first pin axial end face and the second pin axial end face in a first pin axial direction along the first pin center axis. The first pin axial length is defined as a length between the first pin axial end face and the second pin axial end face in the first pin axial direction. The first pin axial length is larger than the first axial sliding surface length by 2 to 7, and the first pin axial length is larger than the second axial sliding surface length by 2 to 7.

According to the thirteenth feature, the chain has even higher wear resistance than those having a first pin axial length relative to the first axial sliding surface length and a first pin axial length relative to the second axial sliding surface length out of the ranges specified above, which minimizes elongation of the chain and improves drive efficiency.

According to a fourteenth feature of the chain in the present disclosure, the first pin axial length is larger than the first axial sliding surface length by 3.5 to 6, and the first pin axial length is larger than the second axial sliding surface length by 3.5 to 6.

According to the fourteenth feature, the chain has even higher wear resistance than those having a first pin axial length relative to the first axial sliding surface length and a first pin axial length relative to the second axial sliding surface length out of the ranges specified above, which minimizes elongation of the chain and improves drive efficiency.

According to a fifteenth feature of the chain in the present disclosure, the first annular axial protrusion has a first radial thickness defined in a radial direction relative to the first inner link center axis, and the third annular axial protrusion has a second radial thickness defined in a radial direction relative to the third inner link center axis. The first pin includes, in a state in which the chain is assembled, a first pin center axis, a first pin axial end face, a second pin axial end face, and a first shaft body extending between the first pin axial end face and the second pin axial end face in a first pin axial direction along the first pin center axis. The first pin axial length is defined as a length between the first pin axial end face and the second pin axial end face in the first pin axial direction. The first pin axial length is larger than the first radial thickness by 6 to 20, and the first pin axial length is larger than the second radial thickness by 6 to 20.

According to the fifteenth feature, the chain has even higher wear resistance than those having a first pin axial length relative to the first radial thickness and a first pin axial length relative to the first radial thickness out of the ranges specified above, which minimizes elongation of the chain and improves drive efficiency.

According to a sixteenth feature of the chain in the present disclosure, the first pin axial length is larger than the first radial thickness by 8 to 15, and the first pin axial length is larger than the second radial thickness by 8 to 15.

According to the sixteenth feature, the chain has even higher wear resistance than those having a first pin axial length relative to the first radial thickness and a first pin axial length relative to the first radial thickness out of the ranges specified above, which minimizes elongation of the chain and improves drive efficiency.

According to a seventeenth feature of the chain in the present disclosure, the first pin includes, in a state in which the chain is assembled, a first pin center axis, a first pin axial end face, a second pin axial end face, and a first shaft body extending between the first pin axial end face and the second pin axial end face in a first pin axial direction along the first pin center axis.

According to the seventeenth feature, the chain having the pin that includes, in a state in which the chain is assembled, the first pin center axis, first pin axial end face, second pin axial end face, and first shaft body extending between the first pin axial end face and the second pin axial end face in the first pin axial direction along the first pin center axis, has higher wear resistance, which minimizes elongation of the chain and improves drive efficiency.

According to an eighteenth feature of the chain in the present disclosure, in a circumference direction of the first pin, the first pin is formed with a first retaining portion circumferentially all around at the first pin axial end face, and, in a circumference direction of the first pin, the second pin is formed with a second retaining portion circumferentially all around at the second pin axial end face.

According to the eighteenth feature, the chain having the first retaining portion and second retaining portion has higher wear resistance, which minimizes elongation of the chain and improves drive efficiency. The first retaining portion and second retaining portion increase the chain strength.

According to a nineteenth feature of the chain in the present disclosure, the first retaining portion is formed all around the first pin axial end face by a swaging process, and the second retaining portion is formed all around the second pin axial end face by a swaging process.

According to the nineteenth feature, the chain having a first retaining portion and a second retaining portion formed by a swaging process has higher wear resistance, which minimizes elongation of the chain and improves drive efficiency. The swaging process that forms the first retaining portion and second retaining portion allows the chain to be produced with excellent efficiency.

According to a twentieth feature of the chain in the present disclosure, the first pin axial end face is coplanar with the second outer link surface or positioned between the first outer link surface and the second outer link surface in the first pin axial direction along the first pin center axis. The second pin axial end face is coplanar with the fourth outer link surface or positioned between the third outer link surface and the fourth outer link surface in the first pin axial direction along the first pin center axis.

According to the twentieth feature, with the first pin axial end face and the second pin axial end face being positioned as specified above, the chain has higher wear resistance, which minimizes elongation of the chain and improves drive efficiency. According to the twentieth feature, with the first pin axial end face and the second pin axial end face being positioned as specified above, the chain can move smoothly between adjacent sprockets when the gear is changed. The chain can be reduced in size in the pin axial direction, which enables an increase in the number of rear sprockets.

According to a twenty-first feature of the chain in the present disclosure, the first pin passes through the first outer link opening and the third outer link opening with a press fit, in a state in which the chain is assembled.

According to the twenty-first feature, the chain, with its first pin passing through the first outer link opening and the third outer link opening with a press fit in a state in which the chain is assembled, has higher wear resistance, which minimizes elongation of the chain and improves drive efficiency. The first pin passing through the first outer link opening and the third outer link opening with a press fit enhances the chain strength.

According to a twenty-second feature of the chain in the present disclosure, the first inner link plate includes a first inner link recess sunken from the first inner link surface toward the second inner link surface at least in the first inner link intermediate portion. The second inner link plate includes a second inner link recess sunken from the third inner link surface toward the fourth inner link surface at least in the second inner link intermediate portion.

According to the twenty-second feature, the chain having the first inner link recess and second inner link recess has higher wear resistance, which minimizes elongation of the chain and improves drive efficiency. The first inner link recess and second inner link recess ensure smooth engagement between the sprocket teeth of the sprockets and the inner link plates even when the chain size is reduced in the pin axial direction.

According to a twenty-third feature of the chain in the present disclosure, the second inner link surface of the first inner link intermediate portion is flat, and the fourth inner link surface of the second inner link intermediate portion is flat.

According to the twenty-third feature, the chain having the flat second inner link surface of the first inner link intermediate portion and the flat fourth inner link surface of the second inner link intermediate portion has higher wear resistance, which minimizes elongation of the chain and improves drive efficiency. The flat second inner link surface of the first inner link intermediate portion and the flat fourth inner link surface of the second inner link intermediate portion enable a size reduction of the chain in the pin axial direction and enable an increase in the number of rear sprockets.

According to a twenty-fourth feature of the chain in the present disclosure, the second inner link surface includes a first inner link opening recess around the first inner link opening. The second inner link surface includes a second inner link opening recess around the second inner link opening. The fourth inner link surface includes a third inner link opening recess around the third inner link opening. The fourth inner link surface includes a fourth inner link opening recess around the fourth inner link opening.

According to the twenty-fourth feature, the chain including the first inner link opening recess, second inner link opening recess, third inner link opening recess, and fourth inner link opening recess has even higher wear resistance, which minimizes elongation of the chain and improves drive efficiency. The first inner link opening recess, second inner link opening recess, third inner link opening recess, and fourth inner link opening recess prevent excessive interference between inner link plates and outer link plates.

According to a twenty-fifth feature of the chain in the present disclosure, the first inner link end of the first inner link plate has a first inner link sprocket tooth holding portion designed to hold a tooth of a sprocket when the chain meshes with the tooth of the sprocket. The second inner link end of the first inner link plate has a second inner link sprocket tooth holding portion designed to hold a tooth of a sprocket when the chain meshes with the tooth of the sprocket. The first inner link sprocket tooth holding portion is formed with a first inner link chamfer on the first inner link surface. The second inner link sprocket tooth holding portion is formed with a second inner link chamfer on the first inner link surface.

According to the twenty-fifth feature, the chain includes the first inner link sprocket tooth holding portion and second inner link sprocket tooth holding portion respectively formed with the first inner link chamfer and second inner link chamfer, and has even higher wear resistance, which minimizes elongation of the chain and improves drive efficiency. The first inner link chamfer and second inner link chamfer allow easier engagement between the chain and the teeth of the sprocket while the first inner link sprocket tooth holding portion and second inner link surface tooth holding portion hold the teeth of the sprocket.

According to a twenty-sixth feature of the chain in the present disclosure, the third inner link end of the second inner link plate has a third inner link sprocket tooth holding portion designed to hold a tooth of a sprocket when the chain meshes with the tooth of the sprocket. The fourth inner link end of the second inner link plate has a fourth inner link sprocket tooth holding portion designed to hold a tooth of a sprocket when the chain meshes with the tooth of the sprocket. The third inner link sprocket tooth holding portion is formed with a third inner link chamfer on the third inner link surface. The fourth inner link sprocket tooth holding portion is formed with a fourth inner link chamfer on the third inner link surface.

According to the twenty-sixth feature, the chain includes the third inner link sprocket tooth holding portion and fourth inner link sprocket tooth holding portion respectively formed with the third inner link chamfer and fourth inner link chamfer, and has even higher wear resistance, which minimizes elongation of the chain and improves drive efficiency. The third inner link chamfer and fourth inner link chamfer allow easier engagement between the chain and the teeth of the sprocket while the third inner link sprocket tooth holding portion and fourth inner link surface tooth holding portion hold the teeth of the sprocket.

According to a twenty-seventh feature of the chain in the present disclosure, the plurality of pins include a pin having a pin through hole extending through in a longitudinal direction.

According to the twenty-seventh feature, the chain having the pin through hole has higher wear resistance, which minimizes elongation of the chain and improves drive efficiency. The pin through hole enables a weight reduction of the chain.

A chain drive system according to a twenty-eighth feature of the present disclosure includes: a chain having a plurality of inner link plates, a plurality of outer link plates, and a plurality of pins; and a plurality of sprockets around which the chain is wrapped. The plurality of sprockets include a hardened surface layer on part or all of sliding surfaces that slide against other components, the hardened surface layer containing one of Cr carbide, Ti carbide, V carbide, Nb carbide, Cr nitride, Ti nitride, V nitride, and Nb nitride.

According to the twenty-eighth feature, the hardened surface layer gives higher wear resistance to the sprockets, which improves drive efficiency of the chain drive mechanism.

The chain according to the present disclosure has excellent wear resistance, which minimizes elongation of the chain and improves drive efficiency.

### BRIEF DESCRIPTION OF THE DRAWINGS

FIG. 1 is a diagrammatic view of a bicycle from above;

FIG. 2 is a perspective view of a chain according to a first embodiment;

FIG. 3 is an exploded illustrative view of the chain according to the first embodiment;

FIG. 4 is an enlarged view of a first (second) inner link plate of FIG. 3;

FIG. 5 is an enlarged view of a first (second) outer link plate of FIG. 3;

FIG. 6 is an enlarged view of a first (second) pin of FIG. 3;

FIG. 7 is a longitudinal cross-sectional view of the chain according to the first embodiment before swaging;

FIG. 8 is a partial enlarged view of the chain of FIG. 7 after swaging;

FIG. 9 is an illustrative diagram of measurements of sliding surfaces of the first pin and the first (second) inner link plate;

FIG. 10 is an illustrative diagram of measurements of sliding surfaces of the second pin and the first (second) inner link plate;

FIG. 11 is an illustrative view of a hardened layer on the pin;

FIG. 12A to FIG. 12E are illustrative views of a hardened layer provided on inner link plates;

FIG. 13A to FIG. 13C are illustrative views of a hardened layer provided on outer link plates;

FIG. 14A to FIG. 14C are illustrative views of a hardened layer provided on rollers;

FIG. 15A to FIG. 15C are illustrative views of a hardened layer provided on bushings; and

FIG. 16A and FIG. 16B are illustrative views of a hardened layer provided on sprockets.

### DESCRIPTION OF THE PREFERRED EMBODIMENTS

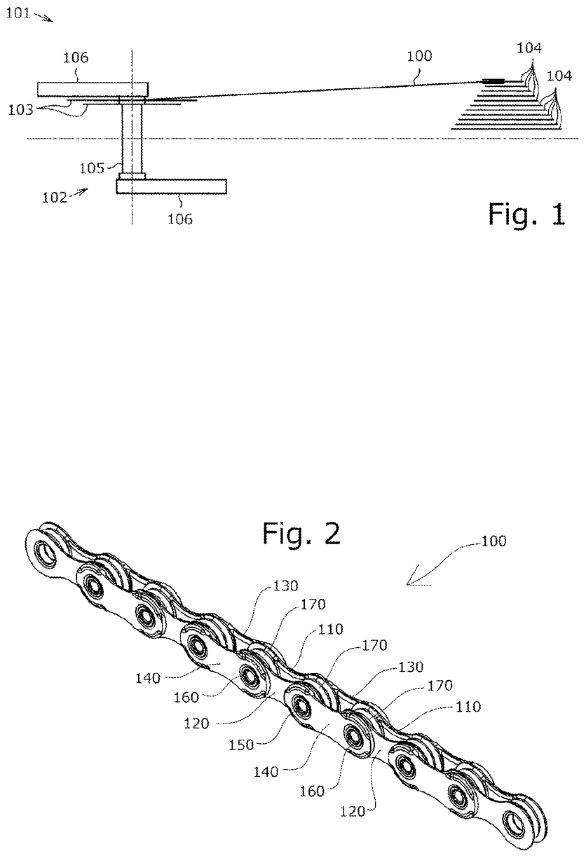

A bicycle to which the chain is applied will be described with reference to FIG. 1.

FIG. 1 shows the bicycle with a drive train 101 viewed from above, i.e., it is a diagrammatic view of the drive train 101.

The drive train 101 is a chain drive type.

The drive train 101 includes a a crank assembly 102, sprockets (hereinafter “sprocket”), and a chain 100.

The sprocket has sprocket teeth for the chain 100 to mesh with.

The sprocket includes a front sprocket 103 and a rear sprocket 104.

The crank assembly 102 includes a crankshaft 105 rotatably supported on the frame of the bicycle, and a pair of crank arms 106 each provided at each of both ends of the crankshaft 105.

A pedal is rotatably attached to the distal end of each crank arm 106.

The front sprocket 103 is mounted to the crankshaft 105 so that it rotates integrally with the crankshaft 105.

The rear sprocket 104 is attached to the hub of the rear wheel.

The chain 100 is wrapped around the front sprocket 103 and the rear sprocket 104.

The drive force applied on the pedals by the user riding the bicycle is transmitted to the rear wheel via the crank arms 106, crankshaft 105, front sprocket 103, chain 100, and rear sprocket 104.

The configuration of the chain 100 according to one embodiment of the present invention will be described in detail with reference to FIG. 2 to FIG. 9.

In this embodiment, each of the inner link plates, outer link plates, and pins are symmetric in the longitudinal direction of the chain 100. The first inner link plate 110 and second inner link plate 120, and the first outer link plate 130 and second outer link plate 140, are symmetric in the width direction of the chain 100. Therefore parts of these components not explicitly shown in the drawings are described herein using corresponding reference numerals. Note, however, in the present invention, each of the inner link plates, outer link plates, and pins may have a shape asymmetric in the longitudinal direction of the chain 100, or a shape asymmetric in the width direction of the chain 100.

As illustrated in FIG. 2, the chain 100 includes a plurality of inner link plates, a plurality of outer link plates, and a plurality of pins.

The plurality of inner link plates include first inner link plates 110 and second inner link plates 120.

The plurality of outer link plates include first outer link plates 130 and second outer link plates 140. The plurality of pins include first pins 150.

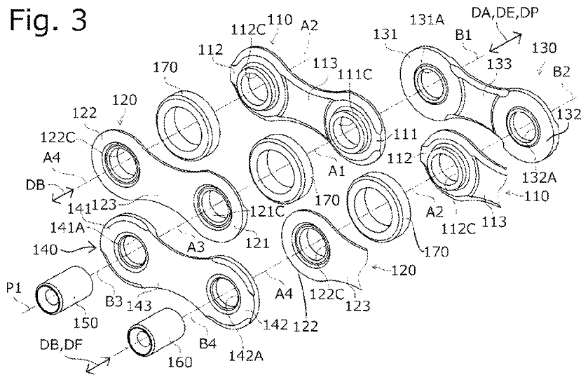

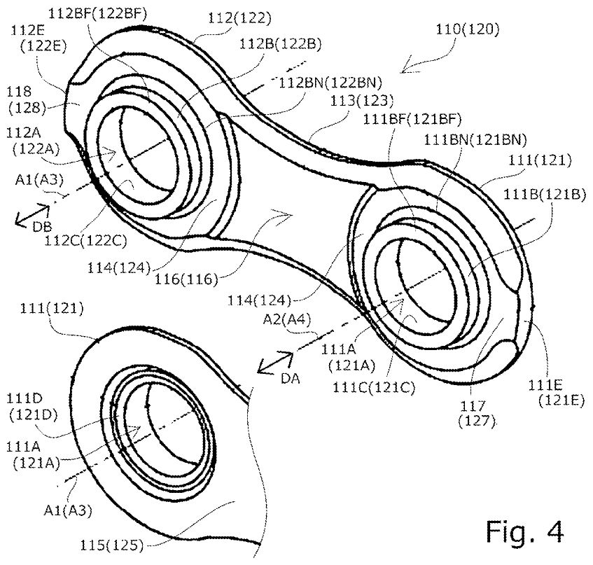

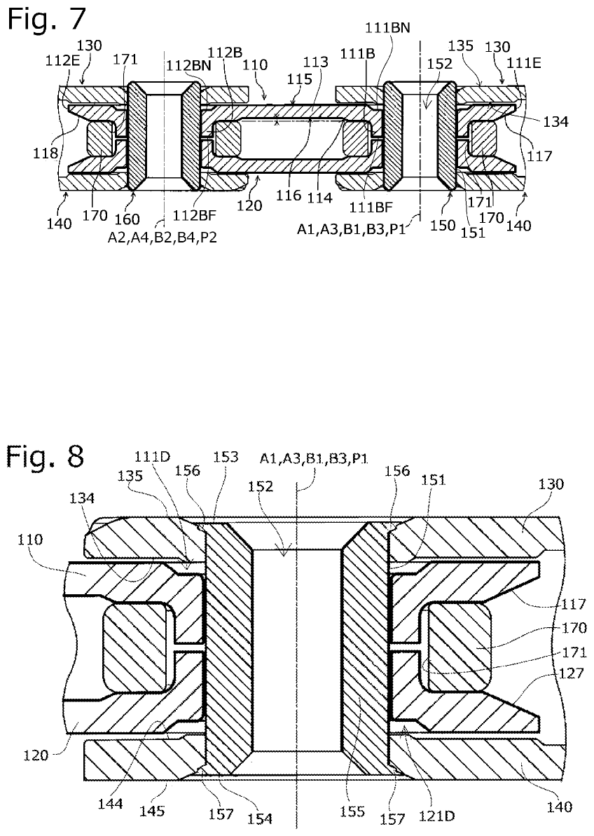

As illustrated, for example, in FIG. 3, FIG. 4, FIG. 7, and FIG. 8, the first inner link plate 110 includes: a first inner link end 111, which includes a first inner link opening 111A having a first inner link center axis Al, and a first annular axial protrusion 111B circumferentially surrounding the first inner link opening 111A around the first inner link center axis Al; a second inner link end 112, which includes a second inner link opening 112A having a second inner link center axis A2 extending parallel to the first inner link center axis Al, and a second annular axial protrusion 112B circumferentially surrounding the second inner link opening 112A around the second inner link center axis A2; a first inner link intermediate portion 113 connecting the first inner link end 111 and the second inner link end 112; a first inner link surface 114; and a second inner link surface 115 on an opposite side from the first inner link surface 114 in a first inner link axial direction DA along the first inner link center axis A1.

The first annular axial protrusion 111B has a first proximal end 111BN connected to the first inner link surface 114, and a first distal end 111BF. The second annular axial protrusion 112B has a second proximal end 112BN connected to the first inner link surface 114, and a second distal end 112BF.

Similarly to the first inner link plate 110, the second inner link plate 120 includes: a third inner link end 121, which includes a third inner link opening 121A having a third inner link center axis A3, and a third annular axial protrusion 121B circumferentially surrounding the third inner link opening 121A around the third inner link center axis A3;

a fourth inner link end 122, which includes a fourth inner link opening 122A having a fourth inner link center axis A4 extending parallel to the third inner link center axis A3, and a fourth annular axial protrusion 122B circumferentially surrounding the fourth inner link opening 122A around the fourth inner link center axis A4; a second inner link intermediate portion 123 connecting the third inner link end 121 and the fourth inner link end 122; a third inner link surface 124 that is designed to face the first inner link surface 114 of the first inner link plate 110 in the first inner link axial direction DA in a state in which the chain 100 is assembled; and a fourth inner link surface 125 on an opposite side from the third inner link surface 124 in a second inner link axial direction DB along the third inner link center axis A3.

The third annular axial protrusion 121B has a third proximal end 121BN connected to the third inner link surface 124, and a third distal end 121BF that comes opposite the first distal end 111BF of the first annular axial protrusion 111B in a state in which the chain is assembled.

The fourth annular axial protrusion 122B has a fourth proximal end 122BN connected to the third inner link surface 124, and a fourth distal end 122BF that comes opposite the second distal end 112BF of the second annular axial protrusion 112B in a state in which the chain 100 is assembled.

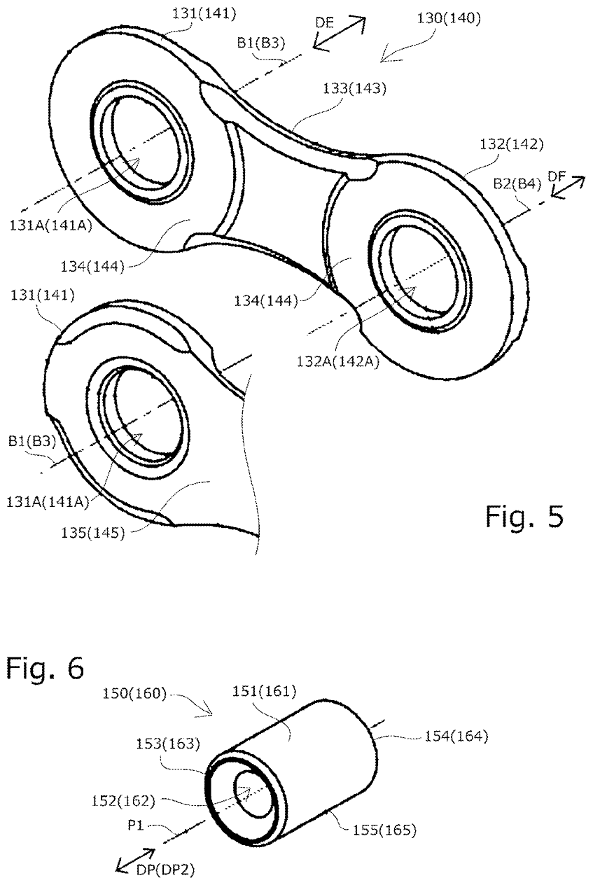

As illustrated, for example, in FIG. 3, FIG. 5, FIG. 7, and FIG. 8, the first outer link plate 130 is designed to directly adjoin the first inner link plate 110 without another inner link plate or another outer link plate interposed therebetween in a state in which the chain 100 is assembled.

The first outer link plate 130 includes: a first outer link end 131, which includes a first outer link opening 131A having a first outer link center axis B1; a second outer link end 132, which includes a second outer link opening 132A having a second outer link center axis B2 extending parallel to the first outer link center axis B1; a first outer link intermediate portion 133 connecting the first outer link end 131 and the second outer link end 132; a first outer link surface 134; and a second outer link surface 135 on an opposite side from the first outer link surface 134 in a first outer link axial direction DE along the first outer link center axis B1.

Similarly to the first outer link plate 130, the second outer link plate 140 is designed to directly adjoin the second inner link plate 120 without another inner link plate or another outer link plate interposed therebetween in a state in which the chain 100 is assembled.

The second outer link plate 140 includes: a third outer link end 141, which includes a third outer link opening 141A having a third outer link center axis B3; a fourth outer link end 142, which includes a fourth outer link opening 142A having a fourth outer link center axis B4 extending parallel to the third outer link center axis B3; a second outer link intermediate portion 143 connecting the third outer link end 141 and the fourth outer link end 142; a third outer link surface 144 that is designed to face the first outer link surface 134 of the first outer link plate 130 in the first outer link axial direction DE in a state in which the chain 100 is assembled; and a fourth outer link surface 145 on an opposite side from the third outer link surface 144 in a second outer link axial direction DF along the third outer link center axis B3.

As illustrated, for example, in FIG. 3 and FIG. 6 to FIG. 8, the first pin 150 is designed to pass through the first outer link opening 131A, third outer link opening 141A, first inner link opening 111A, and third inner link opening 121A in a state in which the chain 100 is assembled, and includes a first outer circumferential surface 151 that slides against the first annular axial protrusion 111B and third annular axial protrusion 121B when the chain 100 is in use.

The plurality of pins include second pins 160. The second pin 160 is designed to pass through the second outer link opening 132A, fourth outer link opening 142A, second inner link opening 112A and fourth inner link opening 122A in a state in which the chain 100 is assembled, and includes a second outer circumferential surface 161 that slides against the second annular axial protrusion 112B and fourth annular axial protrusion 122B when the chain 100 is in use.

The plurality of pins 150 and 160 have a hardened layer on the pin HL containing one of Cr carbide, Ti carbide, V carbide, Nb carbide, Cr nitride, Ti nitride, V nitride, and Nb nitride on part or all of the outer circumferential surfaces 151 and 161.

The plurality of pins 150 and 160 respectively have pin through holes 152 and 162.

The hardened layer on the pin HL should preferably have a sliding surface hardness of 1000 HV or more and 3500 HV or less.

The first proximal end 111BN of the first annular axial protrusion 111B is made of a single material and integrally connected to the first inner link surface 114. The second proximal end 112BN of the second annular axial protrusion 112B is made of a single material and integrally connected to the first inner link surface 114.

The first inner link plate 110 includes a first inner link sliding surface 111C on the inner circumferential surface of the first inner link opening 111A and on the inner circumferential surface of the first annular axial protrusion 111B, extending parallel to the first inner link center axis A1, and sliding against the first outer circumferential surface 151 of the first pin 150.

The second inner link plate 120 includes a second inner link sliding surface 112C on the inner circumferential surface of the third inner link opening 121A and on the inner circumferential surface of the third annular axial protrusion 121B, extending parallel to the third inner link center axis A3, and sliding against the first outer circumferential surface 151 of the first pin 150.

The plurality of inner link plates 110 and 120 have inner link sliding surfaces 111C, 121C, 112C, and 122C that slide against the outer circumferential surfaces 151 and 161 of the pins 150 and 160. The hardened layer on the pin HL should preferably have a higher sliding surface hardness than the surface hardness of the inner link sliding surfaces 111C, 121C, 112C, and 122C.

Part or all of the inner link sliding surfaces 111C, 121C, 112C, and 122C may have a hardened layer RH containing one of Cr carbide, Ti carbide, V carbide, Nb carbide, Cr nitride, Ti nitride, V nitride, and Nb nitride.

The surface roughness of the hardened layer on the pin HL should preferably be smaller than the surface roughness of the inner link sliding surfaces 111C, 121C, 112C, and 122C.

The plurality of pins include a connecting pin for connecting the chain in an endless loop. The connecting pin may have a surface condition that is different from that of the other pins 150 and 160.

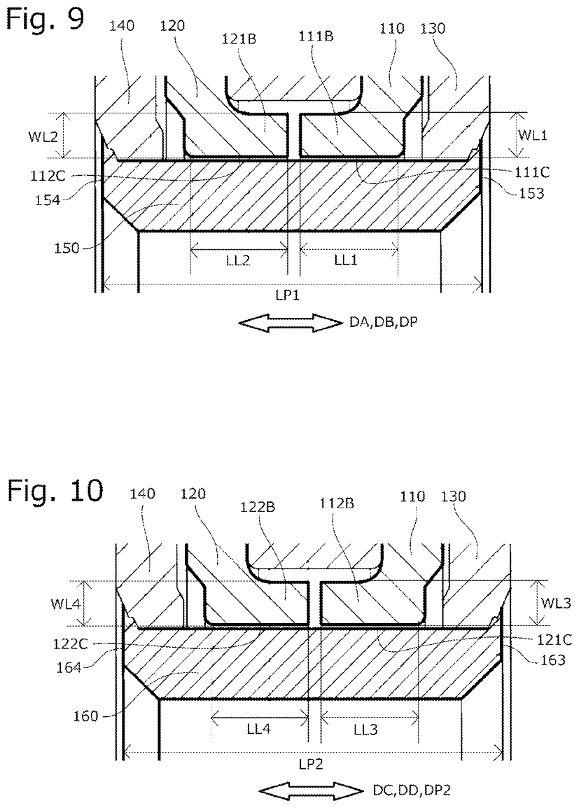

As illustrated in FIG. 9, the first inner link sliding surface 111C should preferably have a first axial sliding surface length LL1 of 0.5 mm or more and 3.5 mm or less in the first inner link axial direction DA.

The second inner link sliding surface 112C should preferably have a second axial sliding surface length LL2 of 0.5 mm or more and 3.5 mm or less in the second inner link axial direction DB.

The first inner link sliding surface 111C should preferably have a first inner link sliding surface hardness of 200 HV or more and 2500 HV or less.

The second inner link sliding surface 112C should preferably have a second inner link sliding surface hardness of 200 HV or more and 2500 HV or less.

As illustrated in FIG. 9, the first inner link sliding surface 111C has the first axial sliding surface length LL1 defined in the first inner link axial direction DA, and the second inner link sliding surface 112C has the second axial sliding surface length LL2 defined in the second inner link axial direction DB.

The first pin 150 includes, in a state in which the chain 100 is assembled, a first pin center axis P1, a first pin axial end face 153, a second pin axial end face 154, and a first shaft body 155 extending between the first pin axial end face 153 and the second pin axial end face 154 in a first pin axial direction DP along the first pin center axis P1.

The first pin axial length LP1 is defined as the length between the first pin axial end face 153 and the second pin axial end face 154 in the first pin axial direction DP. The first pin axial length LP1 should preferably be larger than the first axial sliding surface length LL1 by 2 to 7, and more preferably by 3.5 to 6.

The first pin axial length LP1 should preferably be larger than the second axial sliding surface length LL2 by 2 to 7, and more preferably by 3.5 to 6.

As illustrated in FIG. 10, the third inner link sliding surface 121C has a third axial sliding surface length LL3 defined in the third inner link axial direction DC, and the fourth inner link sliding surface 122C has a fourth axial sliding surface length LL4 defined in the fourth inner link axial direction DD.

The second pin 160 includes, in a state in which the chain 100 is assembled, a second pin center axis P2, a third pin axial end face 163, a fourth pin axial end face 164, and a second shaft body 165 extending between the third pin axial end face 163 and the fourth pin axial end face 164 in a second pin axial direction DP2 along the second pin center axis P2.

The second pin axial length LP2 is defined as the length between the third pin axial end face 163 and the fourth pin axial end face 164 in the second pin axial direction DP2. The second pin axial length LP2 should preferably be larger than the third axial sliding surface length LL3 by 2 to 7, and more preferably by 3.5 to 6.

The second pin axial length LP2 should preferably be larger than the fourth axial sliding surface length LL4 by 2 to 7, and more preferably by 3.5 to 6.

As illustrated in FIG. 9, the first annular axial protrusion 111B has a first radial thickness WL1 defined in the radial direction relative to the first inner link center axis A1. The third annular axial protrusion 121B has a second radial thickness WL2 defined in the radial direction relative to the third inner link center axis A3.

The first pin axial length LP1 is defined as the length between the first pin axial end face 153 and the second pin axial end face 154 in the first pin axial direction. The first pin axial length LP1 should preferably be larger than the first radial thickness WL1 by 6 to 20, and more preferably by 8 to 15.

The the first pin axial length LP1 should preferably be larger than the second radial thickness WL2 by 6 to 20, and more preferably by 8 to 15.

As illustrated in FIG. 10, the second annular axial protrusion 112B has a third radial thickness WL3 defined in the radial direction relative to the second inner link center axis A2. Similarly to the third annular axial protrusion 121B, the fourth annular axial protrusion 122B has a fourth radial thickness WL4 defined in the radial direction relative to the fourth inner link center axis A4.

The second pin axial length LP2 is defined as the length between the third pin axial end face 163 and the fourth pin axial end face 164 in the second pin axial direction DP2. The second pin axial length LP2 should preferably be larger than the third radial thickness WL3 by 6 to 20, and more preferably by 8 to 15.

The second pin axial length LP2 should preferably be larger than the fourth radial thickness WL4 by 6 to 20, and more preferably by 8 to 15.

As illustrated in FIG. 8, in the circumferential direction of the first pin, the first pin is formed with a first retaining portion 156 all around the first pin axial end face 153, and, in the circumferential direction of the first pin, a second retaining portion 157 all around the second pin axial end face 154.

The first retaining portion 156 is formed all around the first pin axial end face 153 by a swaging process, and the second retaining portion 157 is formed all around the second pin axial end face 154 by a swaging process.

The first pin axial end face 153 is coplanar with the second outer link surface 135, or, positioned between the first outer link surface 134 and the second outer link surface 135 in the first pin axial direction DP along the first pin center axis P1. The second pin axial end face 154 is coplanar with the fourth outer link surface 145, or, as illustrated in FIG. 8, positioned between the third outer link surface 144 and the fourth outer link surface 145 in the first pin axial direction DP along the first pin center axis P1.

Preferably, the first pin 150 passes through the first outer link opening 131A and the third outer link opening 141A with a press fit, in the state in which the chain 100 is assembled. Preferably, the second pin 160 passes through the second outer link opening 132A and the fourth outer link opening 142A with a press fit, in the state in which the chain 100 is assembled.

The first inner link plate 110 includes a first inner link recess 116 sunken from the first inner link surface 114 toward the second inner link surface 115 at least in the first inner link intermediate portion 113.

The second inner link plate 120 includes a second inner link recess 126 sunken from the third inner link surface 124 toward the fourth inner link surface 125 at least in the second inner link intermediate portion 123.

The second inner link surface 115 in the first inner link intermediate portion 113 is flat. The fourth inner link surface 125 in the second inner link intermediate portion 123 is flat.

A first inner link opening recess 111D is formed around the first inner link opening 111A in the second inner link surface 115. A second inner link opening recess 112D is formed around the second inner link opening 112A in the second inner link surface 115.

A third inner link opening recess 121D is formed around the third inner link opening 121A in the fourth inner link surface 125. A fourth inner link opening recess 122D is formed around the fourth inner link opening 122A in the fourth inner link surface 125.

The first inner link end 111 of the first inner link plate 110 has a first inner link sprocket tooth holding portion 111E designed to hold a tooth of a sprocket when the chain 100 meshes with the tooth of the sprocket.

The second inner link end 112 of the first inner link plate 110 has a second inner link sprocket tooth holding portion 112E designed to hold a tooth of a sprocket when the chain 100 meshes with the tooth of the sprocket.

A first inner link chamfer 117 is formed to the first inner link sprocket tooth holding portion 111E on the first inner link surface 114. A second inner link chamfer 118 is formed to the second inner link sprocket tooth holding portion 112E on the first inner link surface 114.

The third inner link end 121 of the second inner link plate 120 has a third inner link sprocket tooth holding portion 121E designed to hold a tooth of a sprocket when the chain 100 meshes with the tooth of the sprocket.

The fourth inner link end 122 of the second inner link plate 120 has a fourth inner link sprocket tooth holding portion 122E designed to hold a tooth of a sprocket when the chain 100 meshes with the tooth of the sprocket.

A third inner link chamfer 127 is formed to the third inner link sprocket tooth holding portion 121E on the third inner link surface 124. A fourth inner link chamfer 128 is formed to the fourth inner link sprocket tooth holding portion 122E on the third inner link surface 124.

The first outer link plate 130 and the second outer link plate 140 are joined by the first pin 150 and the second pin 160.

The first inner link plate 110 and the second inner link plate 120 are joined by the first pin 150 the second pin 160.

The assembly of the first inner link plate 110 and the second inner link plate 120 is coupled to the assembly of the first outer link plate 130 and the second outer link plate 140 such as to be rotatable around the center axes of the first pin 150 and the second pin 160. The assemblies of the first inner link plates 110 and the second inner link plates 120, and the assemblies of the first outer link plates 130 and the second outer link plates 140, are alternately arranged and connected into a loop.

The rollers 170 are positioned between the first inner link surface 114 of the first inner link plate 110 and the third inner link surface 124 of the second inner link plate 120 in a state in which the chain 100 is assembled.

The rollers 170 are set between the first inner link end 111 of the first inner link plate 110 and the third inner link end 121 of the second inner link plate 120.

The roller 170 has a roller hole 171 for the annular axial protrusions 111B, 112B, 121B, and 122B to pass through.

The rollers 170 are rotatable relative to the annular axial protrusions 111B, 112B, 121B, and 122B. When the chain 100 is mounted to a bicycle, the rollers 170 contact the sprocket teeth.

In the chain 100 according to this embodiment, the pins 150 and 160 are formed with a hardened layer on the outer circumferential surfaces 151 and 161 at least in portions that slide against the inner link sliding surfaces 111C, 121C, 112C, and 122C of the inner link plates 110 and 120, the hardened layer containing one of Cr carbide, Ti carbide, V carbide, Nb carbide, Cr nitride, Ti nitride, V nitride, and Nb nitride.

These materials, when provided as the hardened layer on the pin surfaces, provide a higher surface hardness than the pin material that is hardened simply by a thermal process. The surface hardness should desirably be within a predetermined range since the higher hardness, while improving wear resistance, will on the other hand increase the wear on the components sliding against the pins.

The chain is moved from one to another of the plurality of sprockets arranged side by side in the width direction when the gear is changed, i.e., it comes out of alignment and is bent in the width direction when in use.

Accordingly, a predetermined clearance is provided between the inner link sliding surfaces and the outer circumferential surfaces of the pins. These components make sliding contact in various changing locations under conditions that are not always constant, and are subjected to varying pressure which can frequently increase dramatically.

The sliding portions of the inner link (curved in a concave shape) does not readily undergo resilient deformation as compared to the pin (curved in a convex shape) and can hardly absorb pressure or impact. Therefore, when they have the same surface hardness, the outer circumferential surface of the pin will suffer more wear or damage than the sliding surfaces of the inner link.

The hardened layer having a higher hardness than that of the sliding surfaces of the inner link, provided on the outer circumferential surface of the pin, increases the wear resistance of the pin, which minimizes elongation of the chain and improves drive efficiency.

The sliding surfaces of the inner link may also be provided with a hardened layer to further increase the wear resistance of the inner link sliding surfaces, which helps minimize elongation of the chain.

While the chain described above in the embodiment is a bicycle chain, a chain with a similar configuration may find other practical applications. Also, a chain having a different configuration from that of the above embodiment can provide similar effects, by adopting the hardened surface layer such as the hardened layer on the pins or on the links.

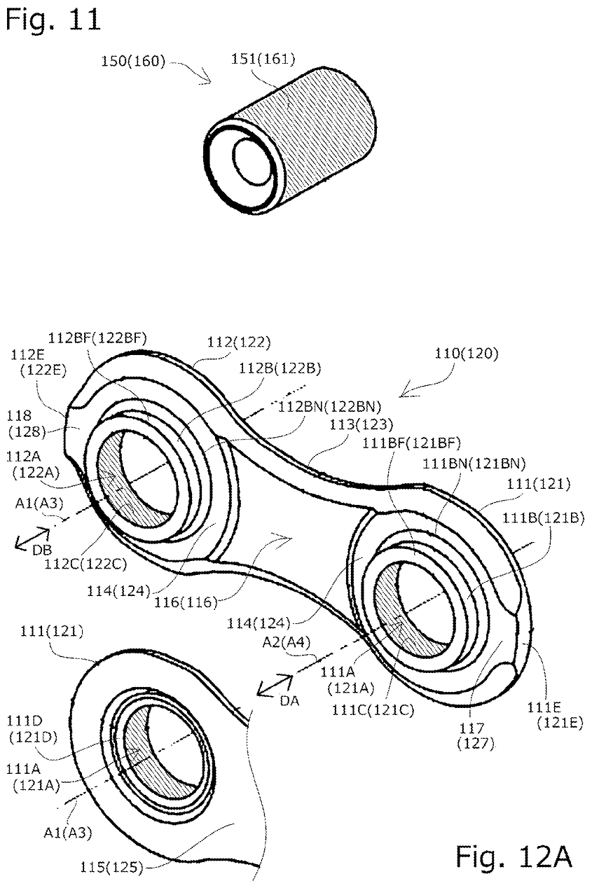

The hardened layer on the pins described above in the embodiment is provided on the outer circumferential surfaces 151 and 161 of the pins 150 and 160 as indicated by hatching in FIG. 11.

The following are examples of locations on other components than the pins 150 and 160 where a hardened surface layer can provide favorable results.

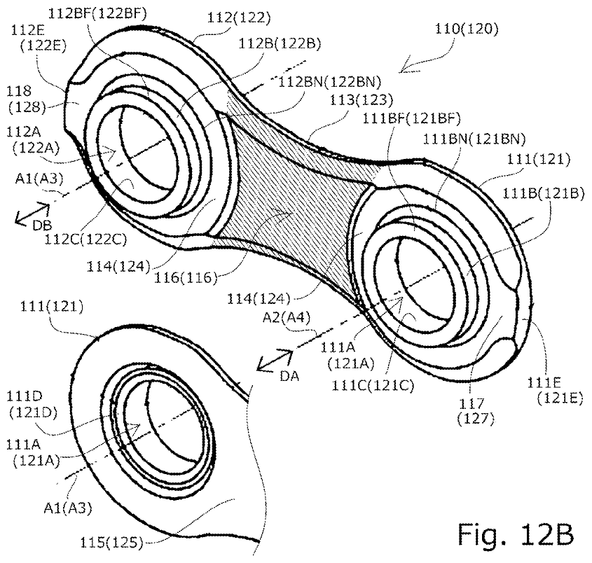

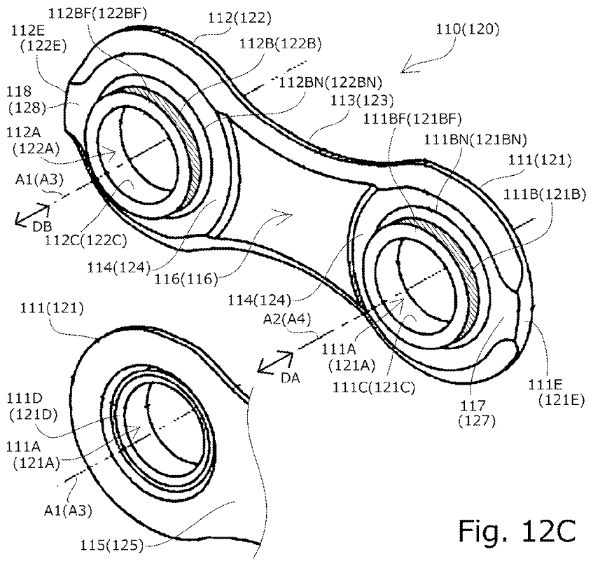

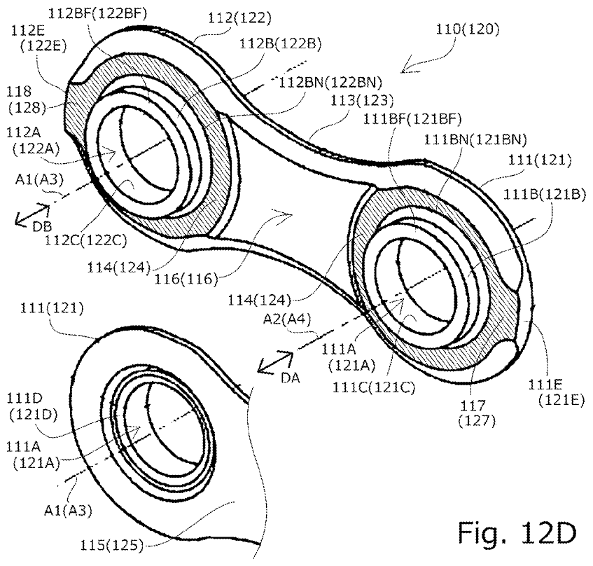

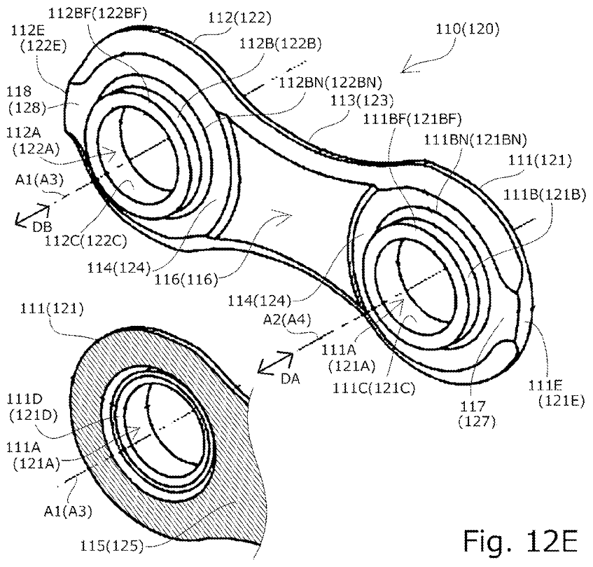

On the inner link plate: the inner link surfaces (e.g. 111C) that slide against the pins 150 and 160, indicated by hatching in FIG. 12A; the inner link recess (116) that slides against the sprocket teeth, indicated by hatching in FIG. 12B; the outer circumferential surfaces of the annular axial protrusions (e.g. 112B) that slide against the inner circumferential surfaces of the rollers, indicated by hatching in FIG. 12C; the inner link chamfers (e.g. 117) that slide against roller side faces, indicated by hatching in FIG. 12D; and the inner link surfaces (e.g., 115) that slide against the outer link plates, indicated by hatching in FIG. 12E.

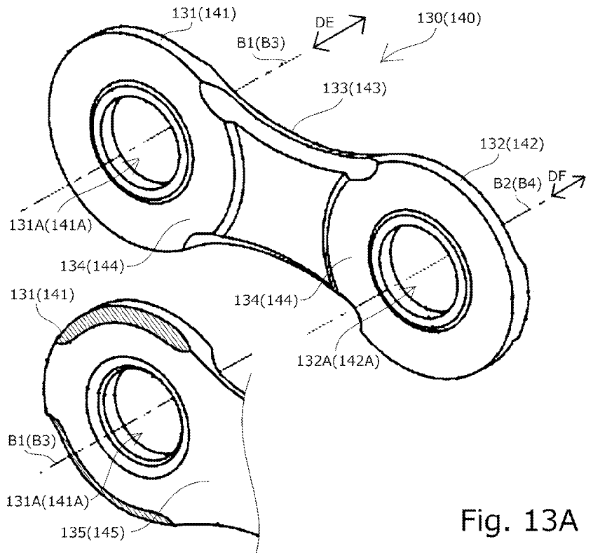

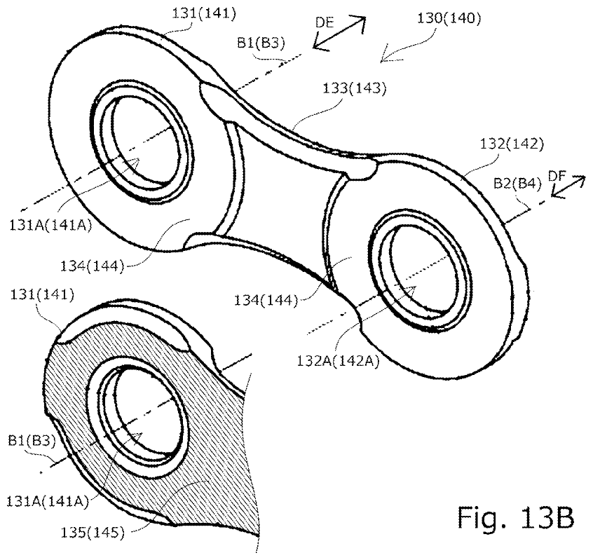

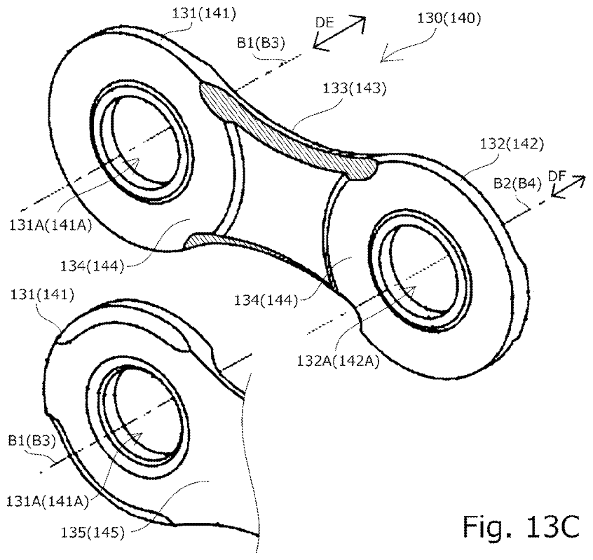

On the outer link plate: chamfers at both ends of the second outer link surface (135), indicated by hatching in FIG. 13A; the flat portion of the second outer link surface (135), indicated by hatching in FIG. 13B; and chamfers on the first outer link intermediate portion (133), indicated by hatching in FIG. 13C.

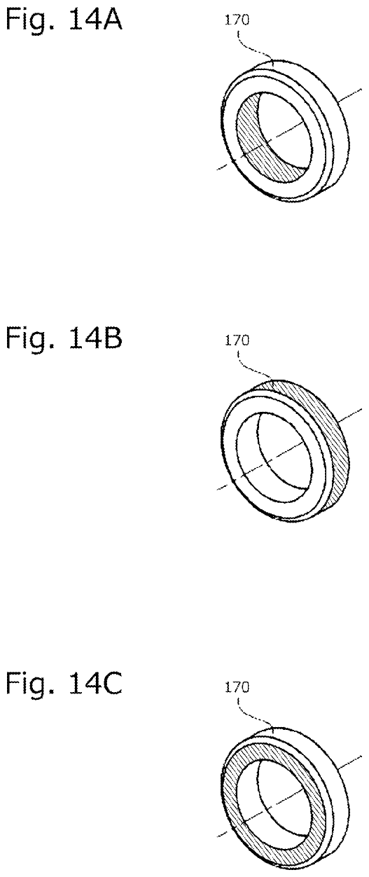

On the roller: the inner circumferential surface that slides against the outer circumferential surfaces of the annular axial protrusions of the inner link plate (e.g. 112B), indicated by hatching in FIG. 14A; the outer circumferential surface that slides against the sprocket teeth, indicated by hatching in FIG. 14B; and the side face that slides against the inner link chamfers (e.g., 117), indicated by hatching in FIG. 14C.

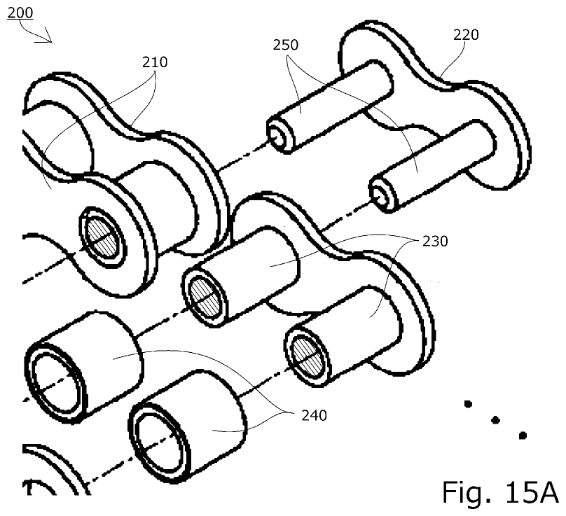

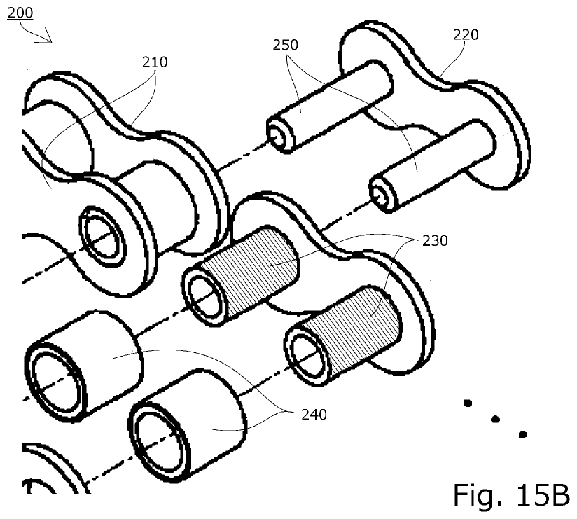

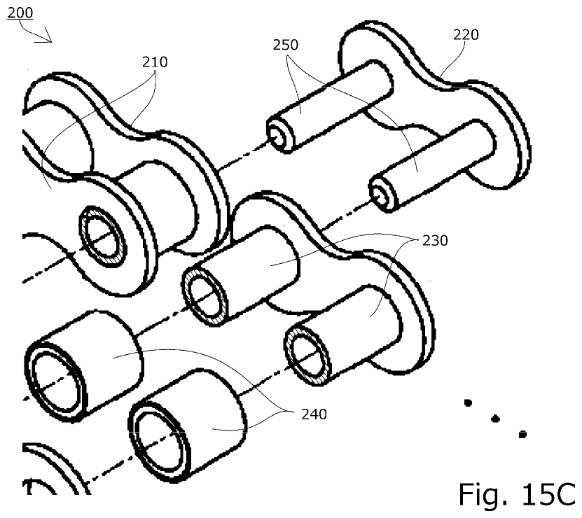

FIG. 15A to FIG. 15C illustrate a chain 200 according to another embodiment, which has bushings 230.

Examples of locations on the bushing 230 in this embodiment where a hardened surface layer can provide favorable results include: inner circumferential surfaces that slide against the outer circumferential surfaces of the pins 250 as shown in FIG. 15A; outer circumferential surfaces that slide against the inner circumferential surfaces of the rollers 240 as shown in FIG. 15B; and end faces sliding against laterally adjacent components, as shown in FIG. 15C.

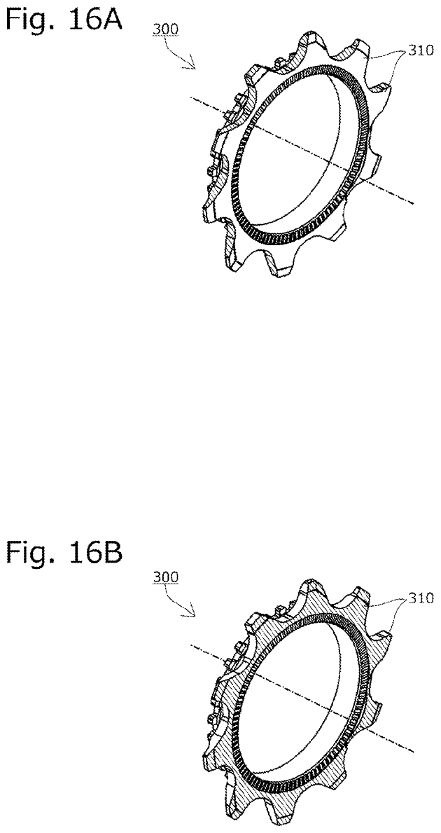

Examples of locations on the sprocket 300 the chain is wrapped around where a hardened surface layer can provide favorable results include the end faces on the outer circumference including the teeth 310 as shown in FIG. 16A, and the distal side face including the slope near the tips of the teeth 310, as shown in FIG. 16B.

What is claimed is:

1. A chain comprising: a plurality of inner link plates; a plurality of outer link plates; and a plurality of pins,
at least any of the plurality of inner link plates, the plurality of outer link plates, or the plurality of pins including a hardened surface layer on part or all of sliding surfaces that slide against other components, the hardened surface layer containing one of Cr carbide, Ti carbide, V carbide, Nb carbide, Cr nitride, Ti nitride, V nitride, and Nb nitride.

2. A chain comprising: a plurality of inner link plates;
a plurality of outer link plates; a plurality of pins; and a plurality of rollers,
the plurality of rollers including a hardened surface layer on part or all of sliding surfaces that slide against other components, the hardened surface layer containing one of Cr carbide, Ti carbide, V carbide, Nb carbide, Cr nitride, Ti nitride, V nitride, and Nb nitride.

3. A chain comprising: a plurality of inner link plates;
a plurality of outer link plates; a plurality of pins; and a plurality of bushings,
the plurality of bushings including a hardened surface layer on part or all of sliding surfaces that slide against other components, the hardened surface layer containing one of Cr carbide, Ti carbide, V carbide, Nb carbide, Cr nitride, Ti nitride, V nitride, and Nb nitride.

4. The chain according to claim 1, wherein the hardened surface layer has a sliding surface hardness of 1000 HV or more and 3500 HV or less.

5. The chain according to claim 1, wherein the hardened surface layer has a higher sliding surface hardness than a surface hardness of sliding surfaces of other components that slide against the hardened surface layer.

6. The chain according to claim 1, wherein
the plurality of pins include a connecting pin for connecting the chain in an endless loop, and
the connecting pin has a surface condition that is different from that of other pins.

7. The chain according to claim 1, wherein
the plurality of inner link plates include a first inner link plate and a second inner link plate,
the plurality of outer link plates include a first outer link plate and a second outer link plate,
the plurality of pins include a first pin,
the first inner link plate includes:
a first inner link end, which includes a first inner link opening having a first inner link center axis, and a first annular axial protrusion circumferentially surrounding the first inner link opening around the first inner link center axis;
a second inner link end, which includes a second inner link opening having a second inner link center axis extending parallel to the first inner link center axis, and a second annular axial protrusion circumferentially surrounding the second inner link opening around the second inner link center axis;
a first inner link intermediate portion connecting the first inner link end and the second inner link end;
a first inner link surface; and
a second inner link surface on an opposite side from the first inner link surface in a first inner link axial direction along the first inner link center axis,
the first annular axial protrusion includes a first proximal end connected to the first inner link surface, and a first distal end,
the second annular axial protrusion includes a second proximal end connected to the first inner link surface, and a second distal end,
the second inner link plate includes:
a third inner link end, which includes a third inner link opening having a third inner link center axis, and a third annular axial protrusion circumferentially surrounding the third inner link opening around the third inner link center axis;
a fourth inner link end, which includes a fourth inner link opening having a fourth inner link center axis extending parallel to the third inner link center axis, and a fourth annular axial protrusion circumferentially surrounding the fourth inner link opening around the fourth inner link center axis;
a second inner link intermediate portion connecting the third inner link end and the fourth inner link end;
a third inner link surface designed to face the first inner link surface of the first inner link plate in the first inner link axial direction in a state in which the chain is assembled; and
a fourth inner link surface on an opposite side from the third inner link surface in a second inner link axial direction along the third inner link center axis,
the third annular axial protrusion has a third proximal end connected to the third inner link surface, and a third distal end that is opposite the first distal end of the first annular axial protrusion in a state in which the chain is assembled,
the fourth annular axial protrusion has a fourth proximal end connected to the third inner link surface, and a fourth distal end that is opposite the second distal end of the second annular axial protrusion in a state in which the chain is assembled,
the first outer link plate is designed to adjoin the first inner link plate without another inner link plate or another outer link plate therebetween in a state in which the chain is assembled,
the first outer link plate includes:
a first outer link end, which includes a first outer link opening having a first outer link center axis;
a second outer link end, which includes a second outer link opening having a second outer link center axis extending parallel to the first outer link center axis;
a first outer link intermediate portion connecting the first outer link end and the second outer link end;
a first outer link surface; and
a second outer link surface on an opposite side from the first outer link surface in a first outer link axial direction along the first outer link center axis,
the second outer link plate is designed to adjoin the second inner link plate without another inner link plate or another outer link plate therebetween in a state in which the chain is assembled,
the second outer link plate includes:
a third outer link end, which includes a third outer link opening having a third outer link center axis;
a fourth outer link end, which includes a fourth outer link opening having a fourth outer link center axis extending parallel to the third outer link center axis;
a second outer link intermediate portion connecting the third outer link end and the fourth outer link end;
a third outer link surface designed to face the first outer link surface of the first outer link plate in the first outer link axial direction in a state in which the chain is assembled; and
a fourth outer link surface on an opposite side from the third outer link surface in a second outer link axial direction along the third outer link center axis,
the first pin is designed to pass through the first outer link opening, the third outer link opening, the first inner link opening, and the third inner link opening in a state in which the chain is assembled, and includes a first outer circumferential surface that slides against the first annular axial protrusion and the third annular axial protrusion when the chain is in use.

8. The chain according to claim 7, wherein
the plurality of pins include a second pin, and
the second pin is designed to pass through the second outer link opening, the fourth outer link opening, the second inner link opening, and the fourth inner link opening in a state in which the chain is assembled, and includes a second outer circumferential surface that slides against the second annular axial protrusion and the fourth annular axial protrusion when the chain is in use.

9. The chain according to claim 7, wherein
the first proximal end of the first annular axial protrusion is made of a single material and integrally connected to the first inner link surface, and
the second proximal end of the second annular axial protrusion is made of a single material and integrally connected to the first inner link surface.

10. The chain according to claim 7, wherein
the inner link includes a first inner link sliding surface and a second inner link sliding surface,
the first inner link plate has the first inner link sliding surface formed on an inner circumferential surface of the first inner link opening and on an inner circumferential surface of the first annular axial protrusion, extending parallel to the first inner link center axis, and sliding against the first outer circumferential surface of the first pin, and
the second inner link plate has the second inner link sliding surface formed on an inner circumferential surface of the third inner link opening and on an inner circumferential surface of the third annular axial protrusion, extending parallel to the third inner link center axis, and sliding against the first outer circumferential surface of the first pin.

11. The chain according to claim 10, wherein
the first inner link sliding surface has a first axial sliding surface length of 0.5 mm or more and 3.5 mm or less in the first inner link axial direction, and
the second inner link sliding surface has a second axial sliding surface length of 0.5 mm or more and 3.5 mm or less in the second inner link axial direction.

12. The chain according to claim 7, wherein
the first annular axial protrusion has a first radial thickness defined in a radial direction relative to the first inner link center axis,
the third annular axial protrusion has a second radial thickness defined in a radial direction relative to the third inner link center axis,
the first pin includes, in a state in which the chain is assembled, a first pin center axis, a first pin axial end face, a second pin axial end face, and a first shaft body extending between the first pin axial end face and the second pin axial end face in a first pin axial direction along the first pin center axis,
the first pin axial length is defined as a length between the first pin axial end face and the second pin axial end face in the first pin axial direction,
the first pin axial length is larger than the first radial thickness by 6 to 20, and
the first pin axial length is larger than the second radial thickness by 6 to 20.

13. The chain according to claim 7, wherein the first pin includes, in a state in which the chain is assembled, a first pin center axis, a first pin axial end face, a second pin axial end face, and a first shaft body extending between the first pin axial end face and the second pin axial end face in a first pin axial direction along the first pin center axis.

14. The chain according to claim 7, wherein the first pin passes through the first outer link opening and the third outer link opening with a press fit, in a state in which the chain is assembled.

15. The chain according to claim 7, wherein
the first inner link plate includes a first inner link recess sunken from the first inner link surface toward the second inner link surface at least in the first inner link intermediate portion, and
the second inner link plate includes a second inner link recess sunken from the third inner link surface toward the fourth inner link surface at least in the second inner link intermediate portion.

16. The chain according to claim 7, wherein
the second inner link surface of the first inner link intermediate portion is flat, and
the fourth inner link surface of the second inner link intermediate portion is flat.

17. The chain according to claim 7, wherein
the second inner link surface includes a first inner link opening recess around the first inner link opening,
the second inner link surface includes a second inner link opening recess around the second inner link opening,
the fourth inner link surface includes a third inner link opening recess around the third inner link opening, and
the fourth inner link surface includes a fourth inner link opening recess around the fourth inner link opening.

18. The chain according to claim 7, wherein
the first inner link end of the first inner link plate has a first inner link sprocket tooth holding portion designed to hold a tooth of a sprocket when the chain meshes with the tooth of the sprocket,
the second inner link end of the first inner link plate has a second inner link sprocket tooth holding portion designed to hold a tooth of a sprocket when the chain meshes with the tooth of the sprocket,
the first inner link sprocket tooth holding portion is formed with a first inner link chamfer on the first inner link surface, and
the second inner link sprocket tooth holding portion is formed with a second inner link chamfer on the first inner link surface.

19. The chain according to claim 7, wherein
the third inner link end of the second inner link plate has a third inner link sprocket tooth holding portion designed to hold a tooth of a sprocket when the chain meshes with the tooth of the sprocket,
the fourth inner link end of the second inner link plate has a fourth inner link sprocket tooth holding portion designed to hold a tooth of a sprocket when the chain meshes with the tooth of the sprocket,
the third inner link sprocket tooth holding portion is formed with a third inner link chamfer on the third inner link surface, and
the fourth inner link sprocket tooth holding portion is formed with a fourth inner link chamfer on the third inner link surface.

20. The chain according to claim 1, wherein the plurality of pins include a pin having a pin through hole extending through in a longitudinal direction.
